(19) United States
(12) Patent Application Publication
(10) Pub. No.: US 2013/0059457 A1
(43) Pub. Date: Mar. 7, 2013

(54) CONNECTOR WITH LEVER

(71) Applicant: Takayuki Hori, Yamato (JP)

(72) Inventor: Takayuki Hori, Yamato (JP)

(73) Assignee: MOLEX INCORPORATED, Lisle, IL (US)

(21) Appl. No.: 12/374,385

(22) PCT Filed: Jul. 18, 2007
(86) PCT No.: PCT/IB2007/046669

§ 371 Date: Oct. 26, 2012

(30) Foreign Application Priority Data
Jul. 19, 2006 (JP) 2006-196807

(51) Int. Cl. H01R 11/22

(52) U.S. Cl. 439/270

(57) ABSTRACT

A connector is provided with a rotatable toggle lever which is movable between a first position where the connector is fitted to a counterpart connector and a second position in which the connector is secured to the counterpart connector. The connector includes a housing and a lock member for locking the lever at the second position. The lock member has a body portion extending approximately parallel with one wall surface of the housing. The lock member has a locking engaging projection portion for engagement with the lever and, at one end of the body, has a releasing operation portion for releasing the engagement of the projection. A first connection portion connects the other end of the body portion to the one wall surface while second connection portions are arranged on both sides of the releasing operation portion to connect the one end of the body portion to the one wall surface. The lock member further includes cable protective projections projecting from the surfaces of the second connection portions in a direction away from the one wall surface. The lever includes a cross frame portion having a concave portion formed in a position located adjacent the releasing operation portion when the lever is in the second position.

### BACKGROUND OF THE INVENTION

1. Field of the Invention

The present invention relates to a connector with a lever.

2. Description of the Related Art

Conventionally, a connector to be fitted in a counterpart connector disposed on a sidewall of a casing accommodating an electronic apparatus such as a control device or the like for various equipment has an engaging lever having an engaging hole, so that the connector is fitted in the counterpart connector with an increased fitting force by turning the engaging lever in a state that the engaging hole is engaged with an engaging projection disposed on the casing (for example, refer to Japanese Patent Application Laid-Open (Kokai) No. 2005-317384).

FIG. 9 is a perspective view illustrating a conventional connector.

In the figure, reference numeral 301 designates a housing of a conventional connector, which is made of an insulating material such as synthetic resin. In a fitting surface of the housing 301, a plurality of insertion openings 302 into which counterpart terminals of a counterpart connector (not shown) are inserted are formed. Herein, the counterpart connector is a connector disposed on a sidewall of a casing or the like accommodating an electronic apparatus, and an engaging projection is disposed on the sidewall or a housing of the counterpart connector.

In addition, an engaging lever 303 with a side surface having an engaging hole 304 functioning as a cam groove is rotatably attached to the housing 301. When fitting the connector in the counterpart connector, the engaging hole 304 is brought into engagement with the engaging projection and the engaging lever 303 is rotated. Consequently, the engaging projection moves along the sidewall of the engaging hole 304 and the connector is pulled closer to the counterpart connector by the functioning of the engaging hole 304 as the cam groove to thereby be firmly fitted with each other. In this case, the engaging lever 303 having the engaging hole 304 engaged with the engaging projection functions as a toggle mechanism and a great fitting force required for fitting the connector in the counterpart connector is generated by rotating the engaging lever 303 with a small force. The orientation of the engaging lever 303 illustrated in FIG. 9 is the position when fitting of the connector in the counterpart connector is completed.

A lock arm 305 is integrally formed with the upper wall of the housing 301 for holding the engaging lever 303 in the position illustrated in FIG. 9. One end of the lock arm 305 (not shown) is a member formed in the shape of a cantilever connected to the upper wall of the housing 301, and the lock arm 305 holds and locks the engaging lever 303 when an engaging projection formed in the middle of the member in the shape of the cantilever engages with the engaging lever 303. When the lock is released, an operator may push down on the area in the vicinity of the free end (end on the fitting surface side) of the lock arm 305 by a finger or the like so as to release the engaging state of the engaging projection formed in the middle of the member in the shape of the cantilever with the engaging lever 303.

In addition, a cover member 306 is integrally formed with the upper wall of the housing 301 for covering the upper side in the vicinity of the free end of the lock arm 305. Generally, in a workshop for performing the fitting operation of the connector in the counterpart connector, other operations such as a wiring operation of lead cables (not shown) connected to the connector will be performed after completion of the fitting operation. In such a case, there is a risk that the lead cables enter the space between the upper wall of the housing 301 and the free end of the lock arm 305, and catch and lift the free end of the lock arm 305. In this case, by covering the upper side in the vicinity of the free end of the lock arm 305 by the cover member 306, the lead cables can be prevented from entering the space between the upper wall of the housing 301 and the free end of the lock arm 305, and consequently, the free end of the lock arm 305 can be prevented from being lifted.

### SUMMARY OF THE INVENTION

In the above-described conventional art, since the cover member 306 covers the upper side in the vicinity of the free end of the lock arm 305, it interferes with the operation of the operator's finger or the like for pushing down the area in the vicinity of the free end of the lock arm 305 when unlocking the lock. In addition, since the cover member 306 is positioned between the free end of the lock arm 305 and the engaging lever 303, the operator cannot operate both the free end of the lock arm 305 and the engaging lever 303 with one finger. Therefore, operability when unlocking the lock may be reduced.

In addition, since the engaging lever 303 interferes with the cover member 306, it is impossible for the engaging lever 303 to move beyond the interfering position in the direction toward the fitting surface. For this reason, the angle of the range of the rotation of the engaging lever 303 becomes small and accordingly, the toggle action exerted by rotating the engaging lever 303 becomes small.

Further, since the lock arm 305 has the shape of a cantilever, that is, a shape of a cantilever of which only one end is fixed, the rigidity is less and the force of the engagement with the engaging lever 303 becomes small. Accordingly, a click feeling generated when locking the engaging lever 303 becomes weak and therefore the operator cannot appropriately perceive that the engaging lever 303 is locked, resulting in reduction of the operating efficiency. In addition, since the distortion of the position of the lock arm 305 is increased during molding due to low rigidity, it is necessary to set the distance between the upper wall of the housing 301 and the lock arm 305 larger so as to allow for the distortion. For this reason, the dimension of the housing 301 in the vertical direction will be increased. Further, since the cover member 306 for covering the upper side of the lock arm 305 is required, the dimension of the housing 301 in the vertical direction will be further increased.

It is an object of the present invention to solve the above-described problems of the conventional connector and to provide a connector with a lever, which is arranged such that opposite ends of a plate-like lock member for locking a lever serving as a toggle mechanism are connected to a housing, whereby a member for covering over the lock member may not be required, an unlocking operation of the lock member can be easily performed, the rotating angle of the lever can be increased so as to enhance the toggle action, rigidity of the lock member may be enhanced, a click feeling generated when the lever is locked may be intensified, an operating efficiency can be improved by enhancing operability, moldability is good, and a dimension of the housing can be reduced.

For the above object, a connector with a lever, according to the present invention, includes a housing for accommodating connector terminals; a lever rotatably mounted on the housing and rotatable between a first position corresponding to an initial position when the connector is fitted in a counterpart connector and a second position in which the fitting of the connector in the counterpart connector is completed; a lock member for locking the lever at the second position; and the lock member comprising a locking engaging projection portion for engagement with the lever and a releasing operation portion for releasing the engagement of the locking engaging projection portion, the lock member having opposite ends connected to the housing.

In another aspect of the connector with a lever according to the present invention, the lock member comprises a body portion extending approximately in parallel with one wall surface of the housing and in a fitting direction and having one end to which the releasing operation portion is connected, a first connection portion connecting the other end of the body portion to the one wall surface, and second connection portions which are arranged on both sides of the releasing operation portion and connecting the one end of the body portion to the one wall surface.

In still another aspect of the connector with a lever according to the present invention, the lock member has an approximately Y-like shape, as seen in a direction perpendicular to the one wall surface.

In still another aspect of the connector with a lever according to the present invention, the lock member further includes cable protective projections formed on the surfaces of the second connection portions so as to project in a direction away from the one wall surface.

In still another aspect of the connector with a lever according to the present invention, the lever includes a cross frame portion which is positioned above the lock member in the second position, and the cross frame portion includes a concave portion formed in a position corresponding to the releasing operation portion in the second position.

According to the present invention, the connector with a lever is so arranged that opposite ends of the plate-like lock member for locking the lever serving as a toggle mechanism are connected to the housing. Thereby, a member for covering the lock member may not be required, an unlocking operation of the lock member can be easily performed, the rotating angle of the lever can be increased so as to enhance the toggle action, rigidity of the lock member may be enhanced, the click feeling generated when the lever is locked may be intensified, an operating efficiency can be improved by enhancing operability, moldability is good, and a dimension of the housing can be reduced.

### BRIEF DESCRIPTION OF THE DRAWINGS

FIG. 1 is a perspective view of the fitting surface side of a connector according to an embodiment of the present invention, illustrating a state that an engaging lever is in the first position;

FIG. 2 is a perspective view of the rear surface side of the connector according to the embodiment of the present invention, illustrating a state that the engaging lever is in the first position;

FIG. 3 is a perspective view of the fitting surface side of the connector according to the embodiment of the present invention, illustrating a state that the engaging lever is in the second position;

FIG. 4 is a perspective view of the rear surface side of the connector according to the embodiment of the present invention, illustrating a state that the engaging lever is in the second position;

FIG. 5 is a perspective view of the fitting surface side of the connector according to the embodiment of the present invention, illustrating a state that the engaging lever is removed;

FIG. 6 is a perspective view of the rear surface side of the connector according to the embodiment of the present invention, illustrating a state that the engaging lever is removed;

FIG. 7 is a perspective view of the rear surface side of the connector according to the embodiment of the present invention, illustrating a state that the connector is fitted in a counterpart connector;

FIG. 8 is a perspective view of the fitting surface side of the connector according to the embodiment of the present invention, illustrating a state that the connector is fitted in the counterpart connector; and

FIG. 9 is a perspective view illustrating a conventional connector.

### DESCRIPTION OF THE PREFERRED EMBODIMENTS

The preferred embodiment of the present invention will be described below in detail with reference to the accompanying drawings.

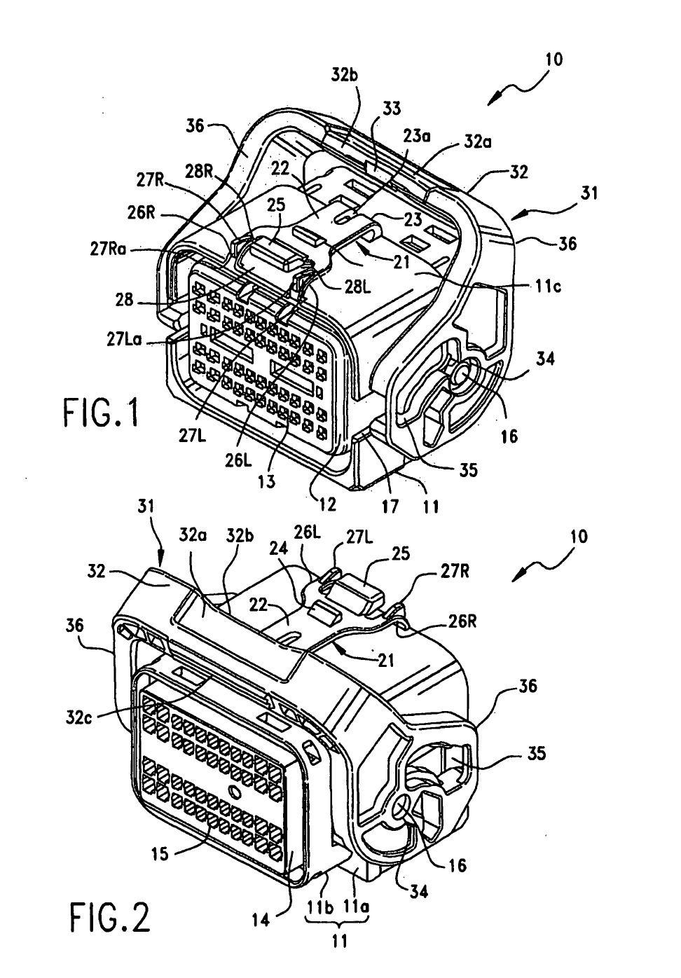

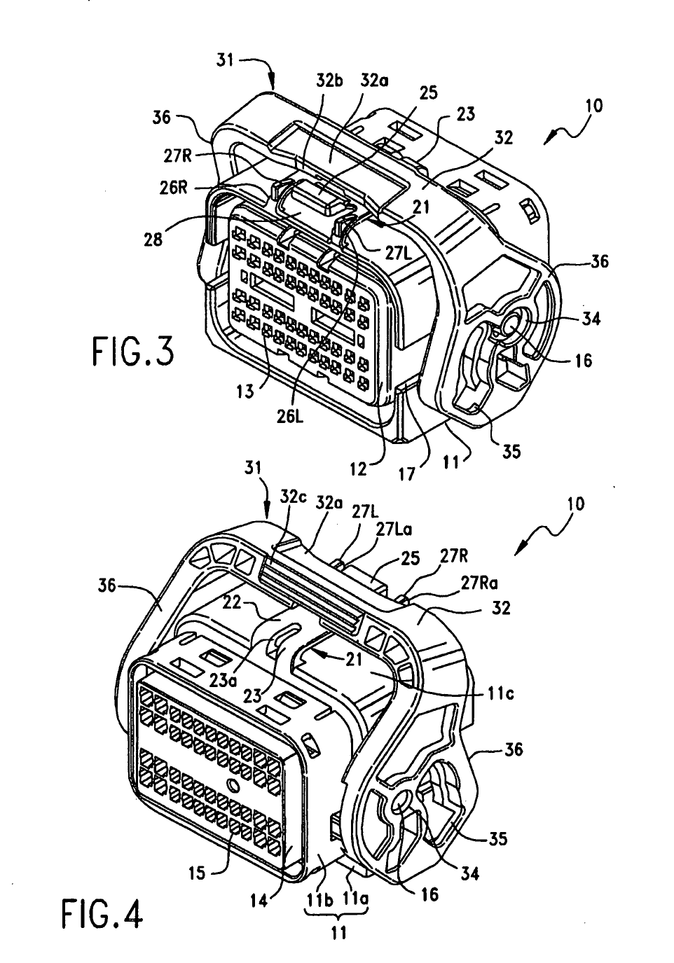

FIG. 1 is a perspective view of the fitting surface side of a connector according to an embodiment of the present invention, illustrating a state where an engaging lever is in the first position; FIG. 2 is a perspective view of a rear surface side of the connector according to the embodiment of the present invention, illustrating a state where the engaging lever is in the first position; FIG. 3 is a perspective view of the fitting surface side of the connector according to the embodiment of the present invention, illustrating a state where the engaging lever is in the second position; and FIG. 4 is a perspective view of the rear surface side of the connector according to the embodiment of the present invention, illustrating a state where the engaging lever is in the second position.

In the figures, reference numeral 10 designates a connector with a lever according to the embodiment of the present invention, and the connector 10 is fitted in a counterpart connector 43 arranged on a sidewall 42 of a casing 41 accommodating an electronic apparatus or the like to be explained later. Herein, the electronic apparatus or the like is provided with a controlling element such as a CPU or an MPU, and a storing element such as a memory, and is an ECU (Electronic Control Unit) for controlling, for instance, an automobile engine, an AT (automatic transmission), an ABS (antilock brake system) or the like, and may be used for any purpose and be any kind of apparatuses.

The connector 10 is a cable connector to be connected to terminal ends of lead cables having a plurality of lead wires, illustration of which is omitted. In addition, when the connector 10 includes a plurality of connector terminals therein to be connected to the terminal ends of respective lead wires, and the connector 10 is fitted in the counterpart connector 43, the connector terminals will be connected to counterpart terminals of the counterpart connector 43, the illustration of which is omitted herein.

In this embodiment, the connector 10 is provided with an integrally formed housing 11 which is made of an insulating material such as synthetic resin, wherein the housing 11 includes a first housing portion 11a on the side of the fitting surface (front and left end surface in FIGS. 1 and 3) and a second housing portion 11b on the side of the rear surface (front and left end surface in FIGS. 2 and 4). In this embodiment, representations of directions such as up, down, left, right, front, rear, and the like, used for explaining the structure and movement of each portion of the connector 10, are not absolute, but relative. These references are appropriate when each portion of the connector 10 is in the position shown in the figures. If the position of the connector 10 changes, however, it is assumed that these references are to be changed according to the change of the position of the connector 10.

In addition, as illustrated in FIGS. 1 and 3, the connector 10 includes an insertion portion 12 accommodated in the first housing portion 11a. The insertion portion 12 is a portion to be inserted in a counterpart housing 43a of the counterpart connector 43. Also, a plurality of terminal insertion holes 13 are formed in the fitting surface of the insertion portion 12, and the ends of the counterpart terminals of the counterpart connector 43 are inserted in the terminal insertion holes 13. Further, connector terminals, which are to be connected to the counterpart terminals, are disposed in respective insertion holes 13. In addition, a space is formed between the sidewalls of the insertion portion 12 and the first housing portion 11a, so as to surround the circumference of the insertion portion 12, and the counterpart housing 43a is inserted in this space. This renders the connector 10 suitable for a water-tight fit with the counterpart connector 43.

Further, as illustrated in FIGS. 2 and 4, the connector 10 includes a connecting portion 14 accommodated in the second housing portion 11b. The connecting portion 14 is a portion to which the lead cables are connected. In addition, a plurality of lead wire insertion holes 15 are formed in the rear surface of the connecting portion 14, and the terminal ends of the lead wires of the lead cables are inserted in the lead wire insertion holes 15. A connector terminal to be connected to the terminal end of each lead wire is disposed in each lead wire insertion hole 15. Furthermore, a space is formed between the sidewalls of the connecting portion 14 and the second housing portion 11b, so as to surround the circumference of the connecting portion 14, and an end portion of a cable cap (not shown) surrounding the lead cables and having functions as a waterproof cover and a dust-proof cover, is inserted in this space.

Support shafts 16 projecting outward and having a circular cross-section are arranged on opposite sidewalls of the first housing portion 11a, and an engaging lever 31 is rotatably mounted on the support shafts 16. The engaging lever 31 is a member formed in the shape of approximately an angled channel or “U” and integrally formed of an insulating material such as synthetic resin, and has a cross frame portion 32 extending in a transverse direction and leg portions 36 connected to opposite ends of the cross frame portion 32 and extending in a direction perpendicular to the cross frame portion 32. The leg portion 36 includes a fitting and rotating hole 34 having a circular cross-section. The engaging lever 31 is rotatably mounted on the housing 11, by rotatably mounting the fitting and rotating hole 34 over the support shaft 16.

In addition, an engaging hole 35 functioning as a cam groove is formed in the leg portion 36. The engaging hole 35 engages with an engaging projection 44 provided on the counterpart housing 43a of the counterpart connector 43, and an effect of bringing the connector 10 and the counterpart connector 43 close to each other is realized by relative movement between the engaging hole 35 and the engaging projection 44 caused by the rotation of the engaging lever 31. In other words, when the engaging lever 31 is rotated, the engaging hole 35 and the engaging projection 44 cooperate with each other, so that a fitting force to cause the connector 10 to be fitted in the counterpart connector 43 is generated. In this case, the engaging lever 31 exerts a toggle effect by the function as a lever and the function of the engaging hole 35 as a cam groove, wherein the fitting force becomes greater than force required for rotating the engaging lever 31. Here, the toggle effect can be adjusted by changing elements such as the distance from the fitting and rotating hole 34 in the leg portion 36 to a joint portion with the cross frame portion 32, the shape of the engaging hole 35, the rotating angle of the engaging lever 31 or the like. Qualitatively, if the distance from the fitting and rotating hole 34 in the leg portion 36 to the joint portion with the cross frame portion 32 and the rotating angle of the engaging lever 31 are increased, the toggle effect becomes greater, and therefore the great fitting force can be obtained even when the force to rotate the engaging lever 31 is small.

In this embodiment, the engaging lever 31 may be rotated in the range from the first position illustrated in FIGS. 1 and 2 to the second position illustrated in FIGS. 3 and 4. The first position is an initial position when the connector 10 is fitted in the counterpart connector 43, while the second position is a position when the fitting force is exerted by rotating the engaging lever 31 and the fitting of the connector 10 in the counterpart connector 43 is completed. In addition, an engaging projection entering slot 17, which opens on the fitting surface side, is formed in the first housing portion 11a. Further, as illustrated in FIG. 1, when the engaging lever 31 is in the first position, the engaging hole 35 is in communication with the engaging projection entering slot 17. Consequently, when the connector 10 is fitted in the counterpart connector 43, the engaging projection 44 provided on the counterpart housing 43a of the counterpart connector 43 enters the engaging hole 35 through the engaging projection entering slot 17, thereby it may be engaged with the engaging hole 35.

In addition, a first concave portion 32a, a second concave portion 32b, and an uneven portion 32c are formed on the cross frame portion 32 so as to facilitate a grip by a finger or fingers or the like of the operator, that is, to facilitate the operation performed by the finger or fingers, when the operator performs the operation on the cross frame portion 32 by the finger or finger or the like. The first concave portion 32a is formed in the middle of the cross frame portion 32 such that the outer surface of the cross frame portion 32 in the direction of radius of rotation of the engaging lever 31 becomes concave. In addition, the second concave portion 32b is also formed in the middle of the cross frame portion 32 in a second side in the direction of rotation of the engaging lever 31 such that the surface thereof becomes concave. The uneven portion 32c is mainly used when changing the orientation of the engaging lever 31 from the first position to the second position, that is, when the connector 10 is fitted in the counterpart connector 43, so as to effectively prevent the finger or fingers or the like from slipping off from the cross frame portion 32. Also, the first concave portion 32a and the second concave portion 32b are mainly used when changing the orientation of the engaging lever 31 from the second position to the first position, that is, when releasing the fitting of the connector 10 in the counterpart connector 43, so as to facilitate the unlocking operation of a lock member 21. Particularly, the unlocking operation of the lock member 21 can be easily performed by the second concave portion 32b being a concave portion formed at a position corresponding to the releasing operation portion 25 at the second position. Further, a locking engagement projection portion 33 projects from the surface of the cross frame portion 32 on the opposite side of the first concave portion 32a.

The lock member 21 is integrally connected with one wall, that is, the upper wall in the example shown in the figures, of the first housing portion 11a. The lock member 21 is a plate-like member having an approximately Y-like shape, and includes a body portion 22, a first connection portion 23, a locking engaging projection portion 24, a releasing operation portion 25, a second connection portion 26R, a second connection portion 26L, a cable protective projection 27R, and a cable protective projection 27L.

As illustrated in FIGS. 3 and 4, when the engaging lever 31 is at the second position, and the locking engaging projection portion 24 engages with the locking engagement projection portion 33, the lock member 21 locks the engaging lever 31 so as to prevent the change in the orientation of the engaging lever 31 toward the first position. In addition, when an operator pushes down the releasing operation portion 25 by a finger or the like, the engagement of the locking engaging projection portion 24 with the locking engagement projection portion 33 will be released, and therefore, the orientation of the engaging lever 31 may be changed to the first position.

Next, the structure of the lock member 21 will be explained in detail.

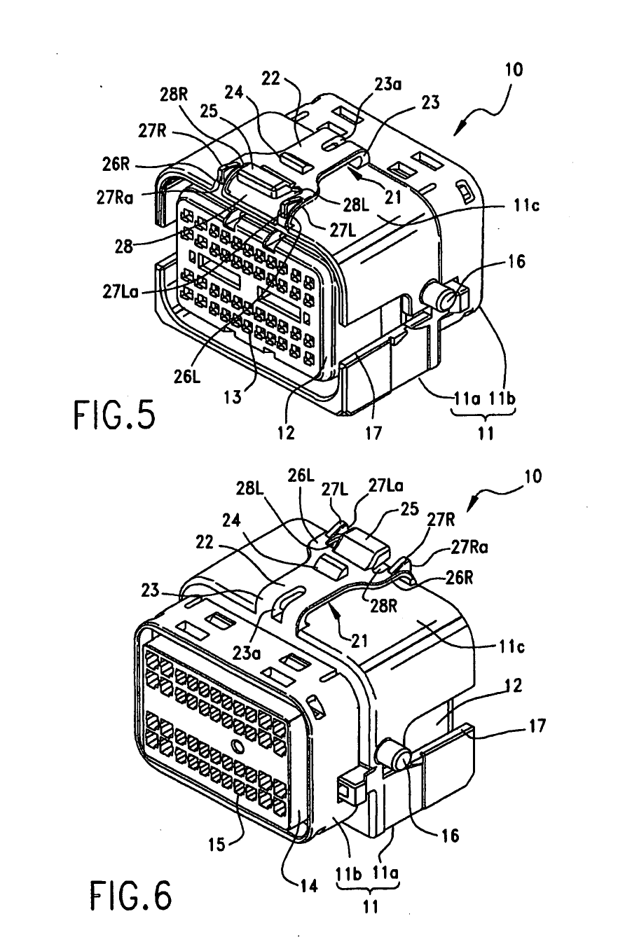

FIG. 5 is a perspective view of the fitting surface side of the connector according to the embodiment of the present invention, illustrating a state that the engaging lever is removed. FIG. 6 is a perspective view of the rear surface side of the connector according to the embodiment of the present invention, illustrating a state that the engaging lever is removed.

As illustrated in FIGS. 5 and 6, the lock member 21 extends in the fitting direction of the connector 10, and is a plate-like member having an approximately Y-like shape, as seen from above. FIGS. 5 and 6 illustrate a state that the engaging lever 31 is removed from the housing 11 for the sake of convenience in explaining the structure of the lock member 21.

The body portion 22 is a plate-like member extending approximately in parallel with the upper wall surface 11c of the first housing portion 11a and in the fitting direction, the first connection portion 23 connects the end of the body portion 22 on the rear side (left, front side in FIG. 6) to the upper wall surface 11c of the first housing portion 11a, and the second connection portions 26R and 26L connect the end of the body portion 22 on the fitting surface side (left, front side in FIG. 5) to the upper wall surface 11c of the first housing portion 11a.

Here, the first connection portion 23 is a curved member, wherein a portion of the first connection portion 23 connected to the upper wall surface 11c of the first housing portion 11a is approximately perpendicular to the upper wall surface 11c and a portion of the first connection portion 23 connected to the body portion 22 is approximately in parallel with the upper wall surface 11c. In the example shown in the figures, a slit 23a is formed in the first connection portion 23. The slit 23a is formed in order to reduce rigidity of the first connection portion 23 and the lock member 21 connected to the first connection portion 23. The rigidity of the lock member 21 can be adjusted by appropriately changing the dimension, the number, and the arrangement of the slit. In addition, the slit 23a may be omitted.

In addition, the second connection portion 26R and the second connection portion 26L are disposed on both sides of the releasing operation portion 25, and are curved members, similar to the first connection portion 23, wherein portions of the second connection portions 26R and 26L connected to the upper wall surface 11c of the first housing portion 11a are approximately perpendicular to the upper wall surface 11c and portions of the second connection portions 26R and 26L connected to the body portion 22 are approximately in parallel with the upper wall surface 11c. In addition, the second connection portion 26R and the second connection portion 26L are connected to side edges of the end of the body portion 22 on the fitting surface side, so that a space 28 is formed between portions 26R and 26L. In the example illustrated in the figures, the width of the space 28 is formed wider than the width of the body portion 22.

The releasing operation portion 25 is disposed in the space 28, projecting from the end of the body portion 22 on the fitting surface side in the direction toward the fitting surface. When an operator brings the releasing operation portion 25 to come close to the upper wall of the first housing portion 11a by a finger or the like, in other words, when the operator presses down the releasing operation portion 25, the body portion 22 can be pressed down. In this case, the body portion 22 is pressed down, mainly by the elastic deformation of the first connection portion 23 and the second connection portions 26R and 26L, whereby the locking engaging projection portion 24 which projects upward from the upper surface of the body portion 22 is pressed down.

Since the releasing operation portion 25 is disposed in the space 28, the position of the releasing operation portion 25 may be set relatively freely. More specifically, since the releasing operation portion 25 can be disposed relatively freely with respect to the positions of the connection portions 26R and 26L, the releasing operation portion 25 can be positioned away from the locking engaging projection portion 24, and the releasing operation portion 25 can be separated from the cross frame portion 32, improving operability.

In addition, the releasing operation portion 25 is formed on the body portion 22 by being separated from the second connection portions 26R and 26L by slits 28R and 28L, respectively. With this configuration, the body portion 22 may be flexed so that the operation for releasing the engagement between the locking engaging projection portion 24 and the locking engagement projection portion 33 can be easily performed. The operation of pushing the releasing operation portion 25 becomes easier if the releasing operation portion 25 is formed to have an upwardly extending shape, as necessary. In this case, the second concave portion 32b disposed in the cross frame portion 32 can be used to form the upwardly extending portion larger.

As described above, when the engaging lever 31 is positioned at the second position (refer to FIGS. 3 and 4), the locking engaging projection portion 24 is engaged with the locking engagement projection portion 33 of the engaging lever 31, and therefore, the engaging lever 31 is locked and is in a state of not being able to change its orientation to the first position. In such a state, when an operator presses down the releasing operation portion 25 with a finger or the like, the locking engaging projection portion 24 is pressed down and therefore the engagement with the locking engagement projection portion 33 is released, hence the engaging lever 31 is unlocked. In this case, although the cross frame portion 32 is positioned above the releasing operation portion 25, since the second concave portion 32b is formed on the cross frame portion 32, the finger or the like of the operator may be moved downward through the second concave portion 32b, thus the operator can easily press down the releasing operation portion 25. Further, by pushing the cross frame portion 32 toward the rear surface in a state of releasing the engagement between the locking engaging projection portion 24 and the locking engagement projection portion 33 by pressing down the releasing operation portion 25, the orientation of the engaging lever 31 can be changed from the second position to the first position.

Since the lock member 21 according to the embodiment of the present invention includes the body portion 22 having opposite ends in the longitudinal direction of the lock member 21 connected to the upper wall of the first housing portion 11a, the rigidity thereof may be increased, compared to a member of which only one end in the longitudinal direction is connected, as explained in the paragraphs in the Background Art. For this reason, when the locking engaging projection portion 24 and the locking engagement projection portion 33 engage with each other so as to lock the engaging lever 31, a sufficient click feeling can be generated. Thereby, since an operator operating the engaging lever 31 by a finger or the like can perceive the click feeling thereof through touching, even when the operator cannot visually recognize the engaging lever 31 due to constraints of an operation position, operation orientation, or the like, the operator may figure out that the engaging lever 31 is locked and the connector 10 is surely fitted in the counterpart connector 43.

The rigidity of the lock member 21 can be adjusted not only by changing the dimension, number, arrangement or the like of the slit 23a, but also by changing the shape, dimension or the like of the second connection portions 26R and 26L. Therefore, the degree of freedom of adjustment is high and the rigidity of the lock member 21 can be easily adjusted to a desired value. Hence, the click feeling and engagement force exerted between the locking engaging projection portion 24 and the locking engagement projection portion 33 may be adjusted to an appropriate value.

In addition, the cable protective projections 27R and 27L are formed on the upper surfaces of the second connection portions 26R and 26L, respectively, to prevent entry of lead cables in the spaces formed between the second connection portion 26R and the releasing operation portion 25, and the second connection portion 26L and the releasing operation portion 25. The cable protective projections 27R and 27L are formed on the curved portions of the second connection portions 26R and 26L, respectively, and entry of the lead cables is prevented by the end sides 27Ra and 27La arranged approximately perpendicular to the upper wall surface 11c. The cable protective projections 27R and 27L are formed to have a height at least corresponding to the lower surface of the releasing operation portion 25. In addition, the releasing operation portion 25 is designed such that it does not extend beyond the end sides 27Ra and 27La in the fitting direction.

There are various possible shapes for the cable protective projections 27R and 27L. By arranging the lower end of the releasing operation portion 25 so that it does not extend beyond the cable protective projection 27R and the cable protective projection 27L in the fitting direction, it is possible to prevent the releasing operation portion 25 from being caught by the lead cables. Generally, in a workshop for conducting the operation of fitting the connector 10 in the counterpart connector 43, other operations such as a handling operation of lead cables connected to the connector 10 are performed even after completion of the fitting operation of the connector 10 and the counterpart connector 43. In such a case, if the cable protective projections 27R and 27L do not exist, the lead cables are in danger of entering a space formed between the upper surface of second connection portion 26R and the releasing operation portion 25 and a space formed between the upper surface of the second connection portion 26L and the releasing operation portion 25, causing the releasing operation portion 25 to be caught and lifted. However, in this embodiment, since the cable protective projections 27R and 27L projecting upward from the upper surfaces of the second connection portions 26R and 26L are formed, respectively, the lead cables are prevented from entering the spaces formed between each of the upper surfaces of the second connection portions 26R and 26L and the releasing operation portion 25.

For this reason, it is not necessary to dispose a member, which prevents entry of the lead cables as described in the paragraphs in the Background Art, so as to cover the space above the lock member 21. Accordingly, the operation of pressing down the releasing operation portion 25 by an operator with a finger or the like when unlocking the engaging lever 31 may not be prevented by the member for preventing the entry of the lead cables. In addition, when the engaging lever 31 is in the second position, the second concave portion 32b of the cross frame portion 32 is located immediately above the releasing operation portion 25, therefore, the operator can push the cross frame portion 32 toward the rear surface while pressing down the releasing operation portion 25 by one finger or the like. This makes it possible to continuously perform operations of unlocking the engaging lever 31 and changing the orientation of the engaging lever 31 from the second position to the first position by one finger or the like, therefore, operability of the fitting releasing operation of the connector 10 and the counterpart connector 43 can be improved. Further, since the second position of the engaging lever 31 can be brought into close contact with the fitting surface, the rotating angle of the engaging lever 31 from the first position to the second position can be increased. Accordingly, the toggle action can be enhanced and hence a great fitting force can be obtained even if the force to rotating the engaging lever 31 is small.

Next, the operation of fitting the connector 10 according to the embodiment of the present invention in the counterpart connector 43 will be explained.

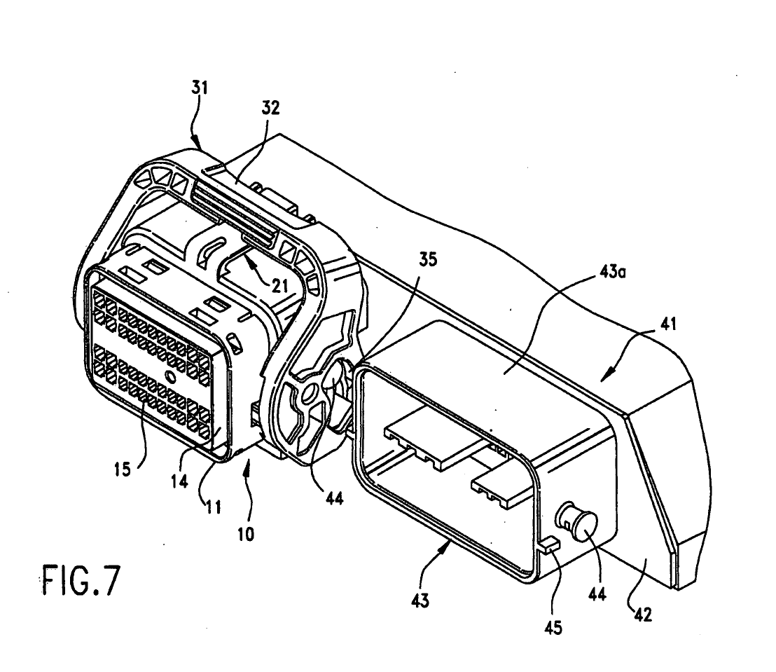

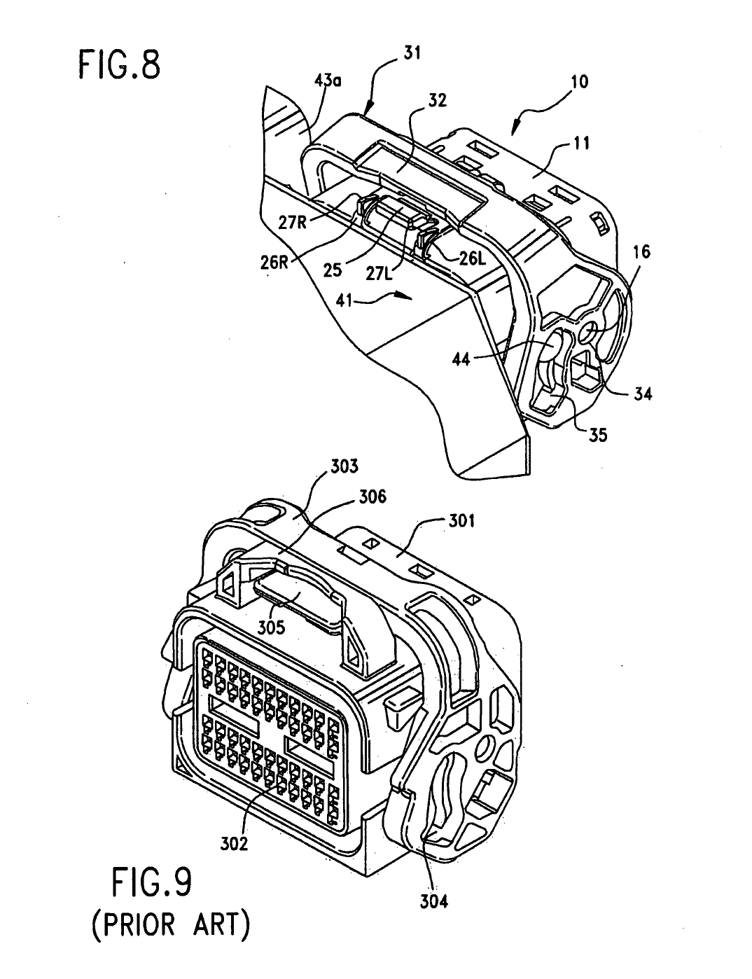

FIG. 7 is a perspective view of the rear surface side of the connector according to the embodiment of the present invention, illustrating a state that the connector is fitted in the counterpart connector. FIG. 8 is a perspective view of the fitting surface side of the connector according to the embodiment of the present invention, illustrating a state that the connector is fitted in the counterpart connector.

As illustrated in FIGS. 7 and 8, the counterpart connector 43 is disposed on the sidewall 42 of the casing 41 having an electronic apparatus or the like accommodated therein. The number of the counterpart connectors 43 may be arbitrarily set, however, in the illustrated embodiment, the number of the counterpart connectors 43 is two, and for the sake of illustration, the connector 10 is fitted in one of the counterpart connectors 43 and the connector 10 is not fitted in the other counterpart connector 43. In addition, the counterpart housing 43a of the counterpart connector 43 is a tubular member whose cross-section has an approximately rectangular shape and is connected to the sidewall 42 at approximately right angles thereto. In addition, outwardly extending engaging projections 44 and auxiliary engaging projections 45 are disposed on opposite side surfaces of the counterpart housing 43a.

The engaging projection 44 is a shaft member whose cross-section has a circular shape and engages with the engaging hole 35 formed in the leg portion 36 of the engaging lever 31 of the connector 10. As described above, the engaging projection portion 44 exerts an effect of rendering the connector 10 and the counterpart connector 43 to come close to each other by the rotation of the engaging lever 31. In addition, the auxiliary engaging projection 45 engages with the engaging projection entering slot 17 formed in the housing 11 of the connector 10 and exerts an effect of positioning the counterpart housing 43a and the housing 11 and an effect as a guide when moving the housing 11 relative to the counterpart housing 43a.

When fitting the connector 10 in the counterpart connector 43, an operator first brings the connector 10, by a finger or the like, close to the counterpart connector 43 in such an orientation that the fitting surface of the connector 10 faces the sidewall 42, and inserts the insertion portion 12 into the counterpart housing 43a. In this case, the counterpart housing 43a is inserted into the space formed between the sidewall of the insertion portion 12 and the first housing portion 11a. In addition, the engaging projection 44 and the auxiliary engaging projection 45 enter into the engaging projection entering slot 17. Further, ends of counterpart terminals (not shown) disposed in the counterpart housing 43a are inserted into the terminal insertion holes 13 formed in the fitting surface of the insertion portion 12. In this instance, the engaging lever 31 is maintained at the first position as illustrated in FIGS. 1 and 2.

Subsequently, when the engaging projection 44 enters the engaging hole 35 formed in the leg portion 36 of the engaging lever 31 in communication with the engaging projection entering slot 17, the operator rotates the engaging lever 31 from the first position to the second position. By this operation, the engaging hole 35 formed in the leg portion 36 of the engaging lever 31 engages with the engaging projection 44, and the relative movement between the engaging projection 44 and the engaging hole 35 causes the connector 10 and the counter connector 43 to move relatively to approach each other. In this case, since a toggle effect is exerted by the function of the engaging lever 31 as a lever and the function of the engaging hole 35 as a cam groove, the fitting force for fitting the connector 10 in the counterpart connector 43 is larger than the force necessary for rotating the engaging lever 31. Also, since the uneven portion 32c is formed on the cross frame portion 32 of the engaging lever 31, any slip-off of a finger or fingers or the like from the cross frame portion 32 is effectively prevented, and the operator can easily rotate the engaging lever 31.

Subsequently, when the engaging lever 31 reaches the second position, as illustrated in FIGS. 7 and 8, the locking engaging projection portion 24 of the lock member 21 engages with the locking engagement projection portion 33 of the cross frame portion 32, and the engaging lever 31 is thus locked. Thereby, the fitting of the connector 10 in the counterpart connector 43 is completed, and the connector terminals of the connector 10 and the counterpart terminals of the counterpart connector 43 are connected to each other. Here, since the operator operating the engaging lever 31 by a finger or the like can perceive the click feeling through touching, the operator can figure out that the engaging lever 31 is locked and the connector 10 is surely fitted in the counterpart connector 43.

When releasing the engagement of the connector 10 and the counterpart connector 43, the operator first presses down the releasing operation portion 25 of the lock member 21, by a finger or the like. When the engagement of the locking engaging projection portion 24 of the lock member 21 and the locking engagement projection portion 33 of the cross frame portion 32 is released, the operator rotates the engaging lever 31 from the second position to the first position. In this case, the operator can press the cross frame portion 32 toward the rear surface while pushing the releasing operation portion 25 by one finger or the like, which makes it possible to continuously perform operations of unlocking the engaging lever 31 and changing the orientation of the engaging lever 31 from the second position to the first position. In this case, since the engaging lever 31 exerts the toggle effect by the function as a lever and the function of the engaging hole 35 as a cam groove, the force required for releasing the engagement of the connector 10 and the counterpart connector 43 becomes greater than the force required for rotating the engaging lever 31.

Subsequently, when the engaging lever 31 reaches the first position, the engaging hole 35 formed in the leg portion 36 of the engaging lever 31 communicates with the engaging projection entering slot 17. For this reason, when the operator moves the connector 10, by a finger or the like, in such a direction that the connector 10 is detached from the counterpart connector 43, the engaging projection 44 enters the engaging projection entering slot 17 and moves together with the auxiliary engaging projection 45 toward the fitting surface side. Thereby, the fitting of the connector 10 and the counterpart connector 43 can be released so that the connector 10 can be detached from the counterpart connector 43.

As described above, the connector 10 according to the embodiment of the present invention is designed such that the opposite ends of the plate-like lock member 21 for locking the engaging lever 31 serving as a toggle mechanism are connected to the housing 11. Therefore, a member for covering over the lock member 21 may not be required, an unlocking operation of the lock member 21 may be easily performed when unlocking the lock member 21, the rotating angle of the engaging lever 31 may be increased so as to enhance the toggle action, rigidity of the lock member 21 may be enhanced, a click feeling generated when the engaging lever 31 is locked can be intensified, an operating efficiency can be improved by enhancing operability, moldability is good, and a dimension of the housing 11 can be reduced.

The lock member 21 comprises the body portion 22 extending approximately in parallel with the upper wall surface 11c of the housing 11 in the fitting direction, and having one end to which the releasing operation portion 25 is connected, the first connection portion 23 connecting the other end of the body portion 22 to the upper wall surface 11c, and the second connection portions 26R and 26L arranged on both sides of the releasing operation portion 25 and connecting the one end of the body portion 22 to the upper wall surface 11c. With this configuration, rigidity of the lock member 21 can be easily adjusted to a desired value, and click and engagement force exerted between the locking engaging projection portion 24 and the locking engaged projection portion 33 may be set to an appropriate value.

In addition, the lock member 21 includes the cable protective projections 27R and 27L formed on the surfaces of the second connection portions 26R and 26L so as to project upward. For this reason, the lead cables are prevented from entering the space formed between each of the upper surfaces of the second connection portions 26R and 26L the releasing operation portion 25, and it is not necessary to dispose a member for preventing entry of the lead cables so as to cover the upper side of the lock member 21.

Further, the engaging lever 31 includes the cross frame portion 32 which is positioned above the lock member 21 in the second position, and the cross frame portion 32 includes the second concave portion 32b formed in a position corresponding to the releasing operation portion 25 in the second position. For this reason, the operation of unlocking the lock member 21 may be easily performed.

The present invention is not limited to the above-described embodiment, and may be changed in various ways based on the gist of the present invention, and these changes are not eliminated from the scope of the present invention.

What is claimed is:

1. A connector with a lever comprising:
(a) a housing for accommodating connector terminals;
(b) a lever rotatably mounted on the housing and rotatable between a first position corresponding to an initial position when the connector is fitted in a counterpart connector and a second position at which the fitting of the connector in the counterpart connector is completed;
(c) a lock member for locking the lever at the second position; wherein
(d) the lock member comprises a locking engaging projection portion for engagement with the lever and a releasing operation portion for releasing the engagement of the locking engaging projection portion, the lock member having opposite ends connected to the housing.

2. The connector with a lever according to claim 1, wherein the lock member comprises a body portion extending approximately in parallel with one wall surface of the housing and in a fitting direction, and having one end to which the releasing operation portion is connected, a first connection portion connecting the other end of the body portion to the one wall surface, and second connection portions arranged on both sides of the releasing operation portion and connecting the one end of the body portion to the one wall surface.

3. The connector with a lever according to claim 2, wherein the lock member has an approximately Y-like shape, as seen in a direction perpendicular to the one wall surface.

4. The connector with a lever according to claim 2, wherein the lock member further comprises cable protective projections formed on the surfaces of the second connection portions so as to project in a direction away from the one wall surface.

5. The connector with a lever according to claim 1, wherein the lever comprises a cross frame portion which is positioned above the lock member in the second position, and the cross frame portion comprises a concave portion formed in a position corresponding to the releasing operation portion in the second position.
